(19) United States
(12) Patent Application Publication
(10) Pub. No.: US 2017/0303573 A1
(43) Pub. Date: Oct. 26, 2017

(54) LIQUID SALT WITH TRACES OF SODIUM

(71) Applicant: Marcelo Patricio ALIAGA MARIN, Santiago (CL)

(72) Inventor: Marcelo Patricio ALIAGA MARIN, Santiago (CL)

(21) Appl. No.: 15/536,663

(22) PCT Filed: Nov. 14, 2014
(86) PCT No.: PCT/CL2014/000060

§ 371 Date: Jun. 16, 2017

(51) Int. Cl. A23L 27/40; A23L 29/00

(52) U.S. Cl. CPC A23L 27/45; A23L 29/015

(57) ABSTRACT

The present invention relates to a liquid salt, with traces of sodium below 0.01%, which is iodized and dissolved in purified water for food use.

### CROSS-REFERENCE TO RELATED APPLICATION

This application claims priority to PCT application no. PCT/CL2014/000060 filed on Nov. 14, 2014.

### FEDERALLY SPONSORED RESEARCH

Not Applicable

### SEQUENCE LISTING OR PROGRAM

Not Applicable

The object of the present invention is a liquid salt, with traces of sodium less than 0.01%, iodized salt, dissolved in purified water for food use.

Some brands with liquid salt are known in Spain: Formentera Liquid Salt, which is based on sodium chloride (20%) mixed with potassium chloride, “El Borriquito” Liquid Salt, which is also a saline solution based on sodium chloride 17%, Añana Salt, and Mineral Liquid Salt, which is a saline solution based on sodium chloride 28%.

Table salt is known, which is characterized by being a white powder of sodium chloride 100%, which leads to a high concentration of sodium intake.

Various observations are made about the above-mentioned products, highlighting three problems:
1. For health, due to the contraindications of sodium intake in humans, for example, hypertension, cardiovascular disease, kidney disease, etc. As long as there is no product that organoleptically meets consumer expectations in terms of flavor, this will not be solved and will remain an important public health problem.
2. All salts containing reduced levels of sodium, for example, liquid sea salts, Biosal, etc., have the problem that the final consumer overdoses on the reduced-sodium salt on foods with the aim of salting meals as usual. Finally, the aggregate dose of sodium is equal to or greater than that using a common salt of 100% sodium chloride. This has led to health professionals not recommending this type of reduced-sodium salts in those cases that require lowering sodium intake for health reasons.
3. A culinary problem because salt crystals do not dissolve and remain as particles in foods, the salty taste not being homogeneous. It also affects the turgor of foods, especially green leaves in salads, leaving them withered.

The purpose of the invention is to obtain a liquid salt with negligible traces of sodium, classified as sodium-free or zero percent sodium, which is organoleptically similar to common table salt (sodium chloride) in terms of taste and salty sensation and meets the international salt iodization standard and Food Health Regulations of Chile. In this way, it is a nutritional substitute item that, through its consumption, benefits human health by eliminating sodium chloride intake and, as far as its application in culinary preparations, improves organoleptic and healthy characteristics in comparison with common salt.

The composition of the liquid salt according to the invention is characterized by the fact that it contains, by weight of the ingredients, 15%-28% potassium chloride, 0.001%-5% potassium citrate, 0.002%-3% monopotassium glutamate, of 0.003-0.1 potassium iodate, and 0.002%-1% potassium sorbate.

In the preceding definition of the invention, as well as in the following description, the contents shown come from mathematical analysis of the concentrations by weight/weight of the contents in solution. This is a common analysis applied to food solutions.

In the framework of this invention, the ingredients that are involved in the formulation are raw materials approved by the FDA, and all of them appear in the Food Health Regulations of Chile.

The composition according to the invention must be in liquid form, for example, with 16%- 28% solids by weight, perfectly diluted by stirring in water. It can contain up to 14% potassium, sodium, and iodized salt.

It has been found that the preparation has notable organoleptic properties, characterized once applied in preparations by its taste and feel that is similar to sodium chloride and its contribution to public health because it does not contain sodium. It thus helps to solve the great global health problem due to high levels of sodium intake, being iodized and having the organoleptic aspects of common salt.

The preferred embodiment of the manufacturing process for this solution is to filter water in such a way as to lower its salt content as much as possible. Then the water is sterilized with ultraviolet light. Then the ingredients are added separately into a stainless steel tank with stirrer and stirred until total dissolution.

The example below illustrates the invention. The parts and percentages are by weight/weight.

### EXAMPLE 1

First, the water to be used is filtered in the following way. It is first circulated in a resin filter to remove most of the salts. Then through an activated carbon filter, odors and flavors inappropriate for pure water are eliminated. Then it is filtered through reverse osmosis equipment to finally obtain ultra-purified water, tasteless, odorless and free of minerals. As the last step, the water passes through an ultraviolet filter to ensure its microbiological quality. This water is stored until its use in the formulation.

Second, 1 liter of this filtered water from the previous step is prepared at room temperature in a stainless steel dissolution tank.

At the same time, the ingredients are weighed for this formulation on precision electronic scales: potassium chloride: 200 grams, potassium citrate: 5 grams, monopotassium glutamate: 3 grams, potassium iodate: 0.1 gram, potassium sorbate: 1 gram.

They are added one by one into the steel dissolution tank and then the equipment is turned on, which through mechanical stirring by rotating steel blades dissolves the solids in 60 minutes. After this time, a saline solution based on potassium salts with a sodium percentage up to 0.01% is obtained.

The liquid salt obtained has the composition shown in Table 1 below, in comparison with table salt, expressed as a percentage of total solids (including moisture).

TABLE 1
Comparative levels of sodium

| | % of total solids | | |
|---|---|---|---|
| | | Common | Formentera |
| | | table | Liquid Salt |
| Constituents | Example 1 | salt (NaCl) | (Spain) |
| POTASSIUM CHLORIDE | 20 | 0 | |
| (KCL) | | | |
| POTASSIUM CITRATE | 0.5 | 0 | |
| MONOPOTASSIUM | 0.3 | 0 | |
| GLUTAMATE | | | |
| POTASSIUM IODATE (KIO3) | 0.03 | | |
| POTASSIUM SORBATE | 0.1 | 0 | |
| ASHES, WITH SODIUM | 0.01 | 39 | 8 |

To taste this liquid salt, it has a mild and well-rounded salty taste, without a metallic or acid taste, very similar to common table salt (NaCl). Once this liquid salt is applied in any food preparation, whether salads, main dishes, meats, etc., it has a taste identical to table salt (NaCl). In sensory test, it receives great approval, so that this liquid salt fully meets the need for a good-tasting zero percent sodium product as a common salt substitute. With regard to dose, the amount of sodium is very low. The sodium values obtained in analysis performed in Dictuc relate to small amounts found in the solution water and some traces in the raw materials.

The amount of sodium in Example 1 per 0.5 cc serving is 0.06 mg. According to the Food Health Regulations of Chile, this amount of sodium is considered sodium-free, compared to 390 mg of sodium in a 1 g serving of common table salt (NaCl) and 80 mg of sodium in 1 ml of Formentera Liquid Salt.

What is claimed:

1. Liquid salt, with traces of sodium, in an aqueous base, CHARACTERIZED in that it comprises the following salts by weight of dry matter:
15%-28% of potassium chloride
0.001%-5% of potassium citrate
0.002%-3% of monopotassium glutamate
0.1%-0.003% of potassium iodate
0.002% to 0.1% potassium sorbate.

2. Liquid salt according to claim 1, CHARACTERIZED in that in its liquid form it has 16%- 28% potassium salts.

3. Liquid salt according to claim 2, CHARACTERIZED in that it comprises up to 0.01% sodium by weight.

4. Composition according to claim 1, CHARACTERIZED in that it has the form of an iodized salt solution.

5. Process for preparing the liquid salt of claim 1, CHARACTERIZED in that water is treated in various filters (resin, carbon activated and reverse osmosis), until reaching the level of purified water, in which potassium salts are dissolved until reaching a percentage of salts by weight corresponding to approximately 21%.

6. Use of the liquid salt according to the claim of Example 1, CHARACTERIZED in that it is used as a SODIUM-FREE food seasoning, common table salt substitute, directly applied to foods, and allows the seasoning of food without adding sodium, versus liquid varieties with sodium content that, on raising the dose, will bring the contents of a common salt.
